(19) United States
(12) Patent Application Publication
(10) Pub. No.: US 2018/0314296 A1
(43) Pub. Date: Nov. 1, 2018

(54) MOBILE DOCKING STATION FOR HANDHELD MOBILE DEVICE

(71) Applicant: Essential Products, Inc., Palo Alto, CA (US)

(72) Inventors: David John Evans, V, Palo Alto, CA (US); Xinrui Jiang, San Jose, CA (US); Andrew E. Rubin, Los Altos, CA (US); Anh Tuan Nguyen, San Mateo, CA (US); Paulina Mustafa, San Francisco, CA (US)

(21) Appl. No.: 15/727,514

(22) Filed: Oct. 6, 2017

Related U.S. Application Data
(60) Provisional application No. 62/492,881, filed on May 1, 2017.

(51) Int. Cl. G06F 1/16; G06F 13/40; H03M 1/66; H04W 4/00; H04M 1/725; H04W 12/06

(52) U.S. Cl. CPC G06F 1/1632; G06F 13/4081; H04W 12/06; H04W 4/008; H04M 1/7253; H03M 1/66

(57) ABSTRACT

A mobile docking station (MDS) includes a surface through which the MDS can electrically and communicatively couple to a handheld mobile device (HMD) while remaining physically unattached from the MDS. The MDS power circuitry configured to electrically couple the MDS and the HMD while a surface of the HMD physically contacts the surface of the MDS, wherein the electrical coupling enables transferring of power between the MDS and the HMD. The MDS also includes communications circuitry configured to communicatively couple the MDS and the HMD while the surface of the HMD physically contacts the surface of the MDS, wherein the communicative coupling enables unidirectional or bidirectional communications between the MDS and HMD.

### CROSS-REFERENCE TO RELATED APPLICATION

This application claims priority to U.S. provisional patent application No. 62/492,881 filed May 1, 2017, which application is incorporated herein in its entirety by this reference.

### TECHNICAL FIELD

The disclosed teachings relate to a mobile docking station and, more particularly, a mobile docking station operable to electrically and/or communicatively couple to a handheld mobile device for seamless transfer of power and data between the mobile docking station and the handheld mobile device.

### BACKGROUND

A docking station provides a simple way to connect a handheld mobile device (HMD) to peripheral devices. Examples of HMDs include computing devices such as smart-watches, smartphones, tablet computers, and laptop computers. Because these HMDs have different form factors, connectors, and uses, docking stations are not standardized and are therefore often designed for a specific make and model of an HMD.

A docking station can convert an HMD into a substitute for a desktop computer, without sacrificing the mobile computing functionality of the HMD. HMDs can dock and undock hot, cold, or standby, depending on the capabilities of the system. In a cold dock/undock, the HMD is completely shut down before docking/undocking. In a hot dock/undock, the HMD remains running when docked/undocked. In a standby dock/undock, an intermediate style is used, which allows the HMD to be docked/undocked while powered on, but requires that it be placed into a sleep mode prior to docking/undocking.

The docking station includes wired connections coupled to connectors that connect with connectors of the handheld mobile device. The use of wired connections ensure that the handheld device can reliably receive power and/or data. For example, the docking station can transfer power from a residential power source to charge the battery of the HMD, and transfer and receive data via a single wired connection with one or more ports. However, docking/undocking an HMD as such is cumbersome and operations are not seamless when docking/undocking. Moreover, wired connections may be undesirable from an aesthetic perspective.

### SUMMARY

The disclosed embodiments include a mobile docking station (MDS) includes a surface through which the MDS can electrically and communicatively couple to a handheld mobile device (HMD) while remaining physically unattached from the MDS. The MDS power circuitry configured to electrically couple the MDS and the HMD while a surface of the HMD physically contacts the surface of the MDS, wherein the electrical coupling enables transferring of power between the MDS and the HMD. The MDS also includes communications circuitry configured to communicatively couple the MDS and the HMD while the surface of the HMD physically contacts the surface of the MDS, wherein the communicative coupling enables unidirectional or bidirectional communications between the MDS and HMD.

Other aspects of the technique will be apparent from the accompanying Figures and Detailed Description.

This Summary is provided to introduce a selection of concepts in a simplified form that is further described below in the Detailed Description. This Summary is not intended to identify key features or essential features of the embodied subject matter, nor is it intended to be used to limit the scope of the embodied subject matter.

### BRIEF DESCRIPTION OF THE DRAWINGS

FIG. 1 illustrates a perspective view of a mobile docking station (MDS) coupled to a handheld mobile device (HMD) according to an embodiment of the present disclosure;

FIG. 2 illustrates a perspective view of an MDS coupled to an HMD according to another embodiment of the present disclosure;

FIG. 3 illustrates a top view of the MDS of FIG. 2 configured to couple to an HMD according to some embodiments of the present disclosure;

FIG. 4 is a block diagram illustrating an MDS electrically and communicatively coupled to an HMD according to some embodiments of the present disclosure;

FIG. 5 is a flowchart illustrating a process for electrically and communicatively coupling an MDS to an HMD according to some embodiments of the present disclosure; and

FIG. 6 is a block diagram illustrating components of an MDS in which embodiments of the present disclosure can be implemented.

### DETAILED DESCRIPTION

The embodiments set forth below represent necessary information to enable those skilled in the art to practice the embodiments and illustrate the best mode of practicing the embodiments. Upon reading the following description in light of the accompanying Figures, those skilled in the art will understand the concepts of the disclosure and will recognize applications of these concepts that are not particularly addressed herein. It should be understood that these concepts and applications fall within the scope of the disclosure and the accompanying embodiments.

The purpose of the terminology used herein is only for describing embodiments and is not intended to limit the scope of the disclosure.

As used herein, unless specifically stated otherwise, terms such as “processing,” “computing,” “calculating,” “determining,” “displaying,” “generating,” or the like, refer to actions or processes of an electronic device that manipulates and transforms data, represented as physical (electronic) quantities within the computer's memory or registers, into other data similarly represented as physical quantities within the device's memory, registers, or other such storage medium, transmission, or display devices.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments necessarily mutually exclusive of other embodiments. Moreover, various features are described that may be exhibited by some embodiments and not by others. Similarly, various requirements are described that may be requirements for some embodiments and not for other embodiments.

Unless the context clearly requires otherwise, throughout the description and the embodiments, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of or connection between the elements can be physical, logical, or a combination thereof. For example, two components may be coupled directly to one another or via one or more intermediary channels or components. As another example, devices may be coupled in such a way that information can be passed there between, while not sharing any physical connection with one another.

Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

The embodiments disclosed herein include a mobile docking station (MDS). The MDS has a relatively small form factor including components that can be electrically and communicatively coupled to a docked handheld mobile device (HMD). Unlike existing docking stations, the MDS has integrated peripheral devices such as electroacoustic transducers (e.g., speakers) that can render audio data provided by a docked HMD. Further, the HMD can be coupled to the MDS wirelessly. Specifically, the MDS may have few physical connectors or no physical connectors required to physically electrically and/or communicatively couple the HMD to the MDS. As such, the HMD can be rapidly docked to the MDS in a manner that enables seamless transfer of power and/or data between the HMD and MDS in response to docking the HMD, and after the HMD has been docked.

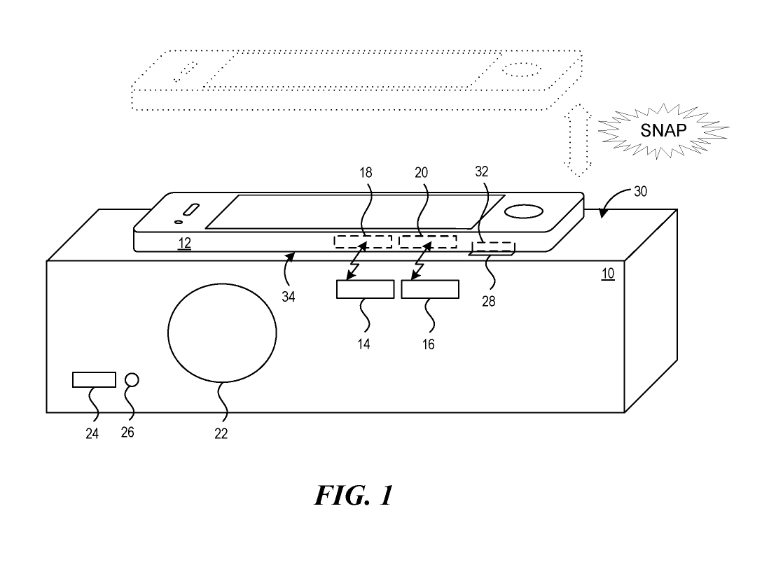

FIG. 1 illustrates a perspective view of an MDS 10 coupled to an HMD 12 according to an embodiment of the present disclosure. For example, the HMD 12 is docked to the MDS when it snaps onto a surface of the MDS via magnetic coupling as described below. In some embodiments, the housing of the MDS 10 is composed of a protective substrate, such as metal or plastic. In some embodiments, the MDS 10 can include a display (not shown) such as a touch-sensitive display and is configured to generate signals responsive to a user contacting the touch-sensitive display or a surface of the MDS.

The MDS 10 has a brick-shaped form factor that includes MDS communications circuitry 14 and MDS power circuitry 16. The MDS communications circuitry 14 facilitates establishing and maintaining one or more communications links with the HMD 12 when docked to the MDS 10. In some embodiments, the MDS communications circuitry 14 can include a wireless transceiver (not shown) to communicate wirelessly with the HMD 12. The MDS communications circuitry 14 can establish one or more Wi-Fi, WiGig, Bluetooth, or any other radio frequency (RF) or cellular links between the MDS 10 and the HMD 12 to communicate data. The MDS 10 can include other features as well, such as a camera and touch-sensitive buttons distinct from a display or a surface of the MDS 10. The camera and/or touch-sensitive buttons may be located within an opaque border on an edge of the MDS 10 used to hide various components that reside within the MDS 10.

As illustrated, the HMD 12 includes HMD communications circuitry 18 for establishing and maintaining communications links with the MDS communications circuitry 14. The MDS communications circuitry 14 and HMD communications circuitry 18 can include other electronics known to persons skilled in the art to enable, facilitate, and/or allow communicating data between the docked HMD 12 and the MDS 10. In some embodiments, the communications links established between the HMD 12 and the MDS 10 can be unidirectional or bidirectional. In particular, by docking the HMD 12 to the MDS 10, a wireless communication link can be established automatically such that data being processed on the HMD 12 is automatically transferred and processed to the MDS 10. For example, audio data being processed and rendered on the HMD 12 can be processed by the HMD 12 but rendered by the speaker 22 of the MDS 10.

The audio port 26 (also referred to as an “audio jack”) is a receptacle or jack that can be used to transmit analog signals, such as audio signals. More specifically, the audio port 26 typically includes two, three, or four contacts that enable audio signals to be readily transmitted when an appropriate plug is inserted into the audio port 26. For example, speakers and headphones can include a plug designed for a 3.5 mm audio jack.

The external port 24 enables the MDS 10 to be physically connected directly to other devices or a power source. For example, the external port 24 could be capable of interfacing with a micro-USB adapter, a 30-pin adapter, or a proprietary bus (e.g., APPLE LIGHTNING). Collectively, the audio port 26 and external port 24 can enable accessories (e.g., headphones, storage devices) to be directly coupled to the MDS 10. However, as noted above, physical connections (i.e., “wired”) are often undesirable for both aesthetic and functional reasons.

In another example, a video being processed and rendered by the HMD 12 (e.g., smartphone) can be processed by the MDS 10 upon docking the HMD 12 and rendered by a display device (not shown) communicatively coupled to the MDS 10 via the external port 24. As such, processing of data by the HMD 12 can be offloaded to the MDS 10 and rendered by a third electronic device (e.g., a display device). In some embodiments, the display of the HMD 12 can render a user interface that allows a user to control the data being processed by the MDS 10 and rendered by an electronic device communicatively coupled to the MDS 10 via the external port 24. In addition, the MDS 10 can include other ports to further distribute data among other electronic device.

In another example, the audio port 26 can be used to couple an external electroacoustic transducer to render audio received by the MDS 10. In addition, the MDS 10 can receive video data from another source (e.g., over a cellular connection) and simultaneously receive user inputs from a touch-sensitive interface of the docked HMD 12. The video data can be rendered by a display device coupled to the MDS 10 via the external port 24 or on the display of the HMD 12 while the audio can be rendered by either the speaker 22 or headphones coupled to the audio port 26.

The MDS power circuitry 16 facilitates managing power of the MDS 10. For example, the MDS power circuitry 16 can be connected to a rechargeable battery (not shown) of the MDS 10 or the external port 24, which can receive power from an external source such as a commercial power grid. The HMD power circuitry 20 can similarly facilitate managing power of the HMD 12. For example, the HMD power circuitry 20 can be connected to a rechargeable battery (not shown) of the HMD 12 or to an external port (not shown) of the HMD 12, which can receive power from an external source such as a commercial power grid. The MDS power circuitry 16 or HMD power circuitry 20 can include other components not shown for the sake of brevity but known by persons skilled in the art to facilitate, enable, or allow the transfer of power between the MDS 10 and the HMD 12.

As illustrated, while docked to the MDS 10, the HMD power circuitry 20 of the HMD 12 can electrically couple to the MDS power circuitry 16 to transfer power between the MDS 10 and the HMD 12. For example, the MDS power circuitry 16 and HMD power circuitry 20 can include inductive mechanisms to transfer power between the MDS 10 to the HMD 12 wirelessly. As such, the MDS 10 or the HMD 12 can act as an external source of power to charge the battery of the HMD 12 or the MDS 10, respectively. For example, while docked to the MDS 10, the battery of the HMD 12 can be supplied with power from the MDS 10's battery or an external power source via the external port 24. Thus, the battery of the HMD 12 or the MDS 10 can be recharged from power supplied by the MDS 10 or the HMD 12, respectively, via their respective power circuitries.

In some embodiments, the MDS 10 can include connectors that physically, magnetically, or wirelessly couple the MDS 10 to the HMD 12. As illustrated, the MDS 10 includes connectors 18 on its surface 32 and the HMD 12 includes corresponding connectors 32 on its surface 34. The MDS connectors 28 and HMD connectors 34 can include, for example, magnets, wireless transceivers, power transceivers, and other components that facilitate transferring power or data between the MDS 10 and the HMD 12. The magnets can be used to magnetically couple the MDS 10 to the HMD 12 in a suitable orientation to align other connectors used to electrically and communicatively couple the MDS 10 and HMD 12. For example, the power transceivers can be conductive connectors that can transfer power when coupled between the MDS 10 and HMD 12.

The docking of the HMD 12 to the MDS 10 can be achieved by placing the HMD surface 34 on the MDS surface 30. In particular, the MDS surface 30 can be a flat surface with or without connectors. Likewise, the HMD surface 34 can be a flat surface with or without connectors. When the HMD surface 34 contacts the MDS surface 30, the docking of the HMD 12 can be established manually or automatically. For example, the MDS surface 30 can detect the HMD surface 34 in contact or relatively close proximity with the MDS surface 30. Once docked, the MDS 10 and HMD 12 are electrically coupled and/or communicatively coupled to enable the transfer of power and data, respectively, between the MDS 10 and the HMD 12. The MDS 10 and the HMD 12 can remain coupled while the HMD 12 remains docked, and decouple when the HMD surface 34 is no longer in contact with, or proximate to, the MDS surface 30.

In some embodiments, the MDS 10 uses an authentication process that automatically authenticates the HMD 12 once it is docked to the MDS 10. For example, once the phone is placed atop the MDS surface 30, the MDS 10 can initiate an authentication routine to authenticate the HMS 12. If authenticated, data being processed and/or rendered by the HMD 12 can be automatically processed and/or rendered by the MDS 10. For example, a song being played by the HMD 12 can be automatically played by the speaker 22 of the MDS 10 once the HMD 12 is docked and authenticated.

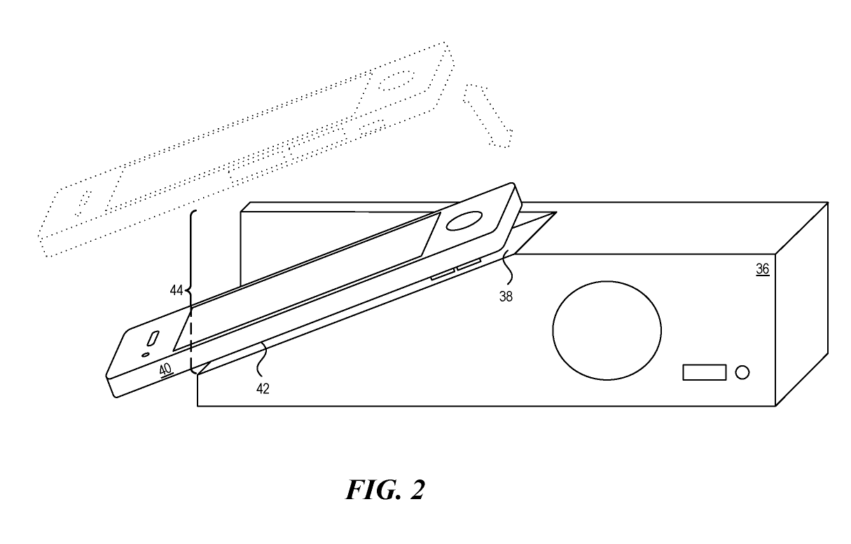

FIG. 2 illustrates a perspective view of an MDS 36 coupled to an HMD 40 according to another embodiment of the present disclosure. The MDS 36 is similar to the MDS 10 except that it includes a recessed portion 44. The recessed portion 44 can receive the HMD 40 at an angle (e.g., 45-degree angle). As such, the HMD 42 can be docked on the MDS 36 by leaning the HMD 36 on the recessed portion 44 as a surface upon which the MDS 36 sits atop. In the illustrated embodiment, the recessed portion 44 can be configured such that it the HMD 40 can be more easily positioned in a suitable location of the MDS surface 38 such that the HMD surface 42 is optimally positioned to be electrically and communicatively coupled to the MDS 36. For example, the recessed portion 44 can have a width substantially identical to the width of the HMD 40. Upon the HMD surface 42 contacting, or being in relatively close proximity to the MDS surface 38, the MDS 36 can automatically authenticate the HMD 40, and electrically and/or communicatively couple the HMD 40 to the MDS 36 to provide seamless operations of the HMD 40 on the MDS 36.

Although illustrated as a docking station for a smartphone, the embodiments of the MDS described herein can also be used with other electronic devices for which it is desirable to eliminate physical ports for transferring data and/or power. For example, similar configurations of docking stations could be utilized with personal computers, tablets, personal digital assistants, game consoles, mobile gaming devices, media players, wearable electronic devices (e.g., watches), network-connected (“smart”) devices (e.g., televisions), internet-of-things (IoT) devices, and other portable electronic devices.

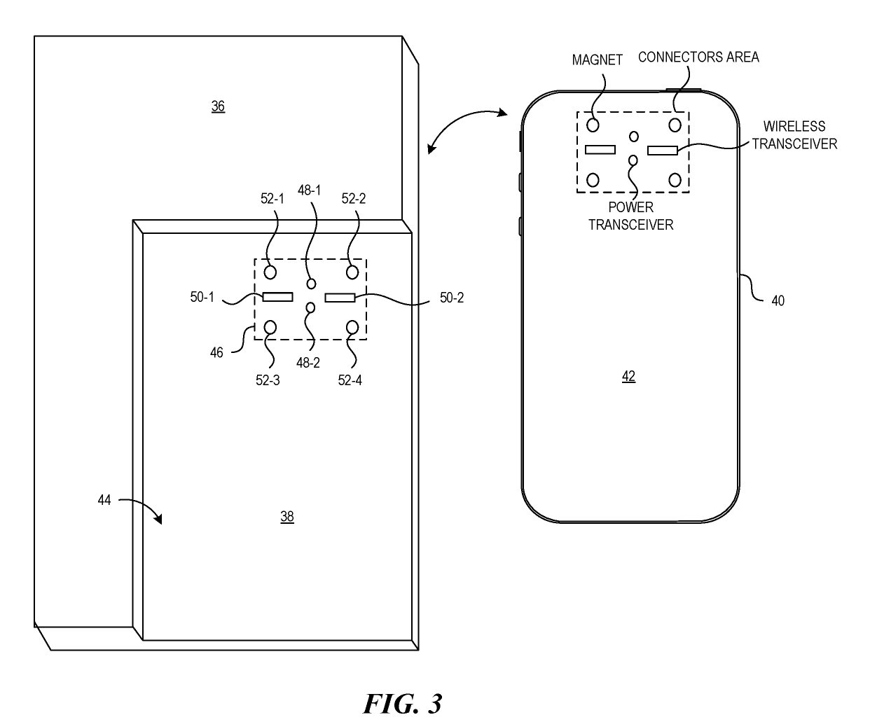

FIG. 3 illustrates a top view of the MDS 36 configured to couple to the HMD 40 according to some embodiments of the present disclosure. The connectors area 46 can enable data and/or power to be wirelessly transferred from the MDS 36 to the HMD 40 (or vice versa) via the MDS surface 38 and HMD surface 42 when the MDS 36 and HMD 40 are in contact or at least within close proximity to each other. For example, a bi-directional communication channel may be established when the HMD 40 is even loosely attached to the connectors MDS 36.

In some embodiments, the connectors area 46 is a wireless bus that is configured to securely receive at least a portion of the HMD 40. As shown, the connectors area 46 can include one or more power transceivers 48, one or more wireless transceivers 50, and/or one or more magnets 52 (collectively referred to as the “bus components”). Some of these bus components could be at least partially exposed. For example, the magnets 52 may be exposed through openings in the MDS surface 38. Additionally or alternatively, some of these bus components could be secured within the MDS surface 38. In such embodiments, the bus components may be selected in order to compensate for signal degradation that occurs as the data signals and/or power signals traverse through the MDS surface 38 or a substrate of the MDS 36. For example, the substrate may be an optically-clear substrate, such as glass or plastic.

The power transceivers 48 are configured to transfer power from a power supply (e.g., a battery) contained within the MDS 36 to the HMD 40 via a wired or wireless coupling. For example, the power transceivers 48 may include one or more electrical contacts (e.g., pin terminals) that are able to physically contact one or more electrical contacts of the HMD 40. As another example, the power transceivers 50 may include integrated circuits that are able to wirelessly transmit power between the MDS 36 and the HMD 40. The power transceivers 48 may be configured to transmit power in accordance with the Qi standard developed by the Wireless Power Consortium or some other wireless power standard.

The wireless transceivers 50 can be communicatively coupled to one or more wireless transceivers of the HMD 40. For the purposes of illustration and simplification, the term “wireless transceiver” is intended to cover components able to transmit data, receive data, or both. Moreover, a single wireless transceiver could include distinct components responsible for transmitting and receiving data signals.

Upon determining that the HMD surface 42 is at least proximate to the connectors area 46 of the MDS surface 38, the wireless transceivers 50 may automatically initiate a connection with the wireless transceivers of the HMD device 40. For example, if the HMD 40 includes multiple digital cameras used to capture image data, the image data may be received by the wireless transceivers 50 from the wireless transceivers of the HMD 40. In some embodiments, an application associated with the HMD 40 could also be downloaded from a network-accessible environment (e.g., a digital distribution platform such as a website or an app store) and/or launched in response to determining that the HMD 40 has been at least loosely attached to the connectors area 46.

The connectors area 46 can include a fastening component that enables the HMD 40 to be attached to the MDS 36. For example, the magnets 52 are arranged around the perimeter of the connectors area 46 so that the HMD 40 is in a predetermined orientation when magnetically attached to the MDS 36. However, other materials and components could also be used. For example, a magnetic film could be deposited on or within the MDS surface 38 and HMD surface 42, or a mechanical track, clips, etc., could be affixed to the MDS surface 38 and HMD surface 42. The predetermined orientation may cause a wireless transmitters of the HMD 40 to be aligned with, or disposed in close proximity to, the wireless transceivers 50 of the MDS surface 38.

In some embodiments, the connectors area 46 is designed so that multiple electronic devices can simultaneously be attached to, and used by, the MDS 36. For example, a user may elect to concurrently dock and utilize a media player, a smartphone, and/or and external storage accessory. In such embodiments, the magnet 52 and/or wireless transceiver 50 may be arranged so that multiple accessories can be utilized without damaging throughput or performance.

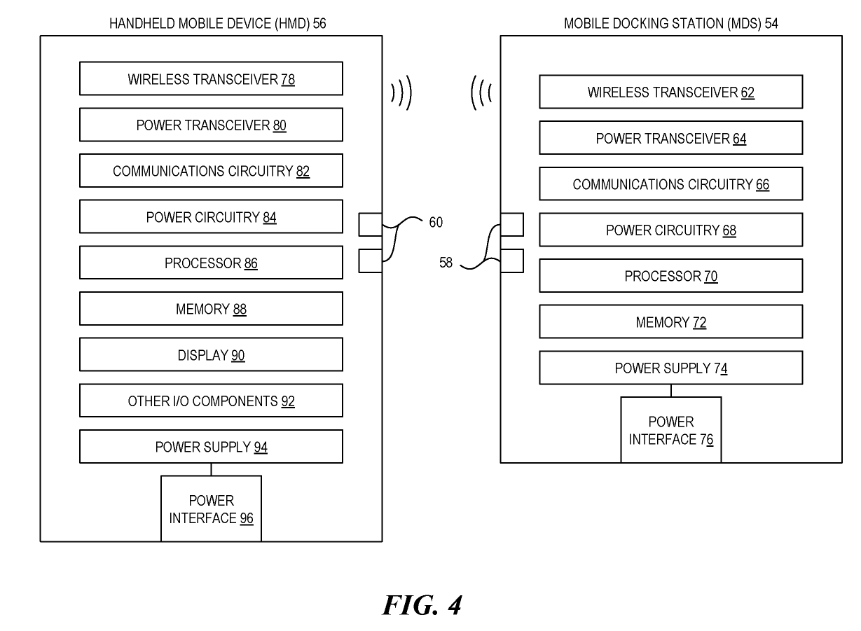

FIG. 4 is a block diagram illustrating an MDS 54 electrically and communicatively coupled to an HMD 56 according to some embodiments of the present disclosure. Various embodiments of the MDS 54 and the HMD 56 can include some or all of these components, as well as additional components not illustrated here but described elsewhere in this disclosure or otherwise known to persons skilled in the art.

The MDS 54 can include a wireless transceiver 62, power transceiver 64, communications circuitry 66, power circuitry 68, a processor 70, memory 72, and a power supply 74 electrically coupled to a power interface 76. These components can be within a housing of the MDS 54 that includes one or more magnets 58 arranged to receive the HMD 56. The HMD 56 can include a wireless transceiver 78, power transceiver 80, communications circuitry 82, power circuitry 84, processor 86, memory 88, display 90, other I/O components 92 such as cameras, and a power supply 92 coupled to a power interface 94. These components can be contained within a housing of the HMD 56 that includes one or more magnets 60 arranged so as to enable the HMD 56 to be attached to the MDS 54. The power supplies 74 and 94 may each include a rechargeable lithium-ion (Li-Ion) battery, a rechargeable nickel-metal hydride (NiMH) battery, a rechargeable nickel-cadmium (NiCad) battery, or any other power source suitable for electronic user devices.

The wireless transceiver 62 can be configured to automatically establish a wireless connection with the wireless transceiver 78 of the HMD 56. The wireless transceivers 62 and 78, in combination with the communications circuitry 66 and 82, allow data to be transmitted between the MDS 54 and HMD 56. More specifically, the wireless transceivers 62 and 78 may communicate with one another using a bi-directional communication protocol, such as Near Field Communication (NFC), wireless Universal Serial Bus (USB), Bluetooth, Wi-Fi, WiGig, a cellular data protocol (e.g., 3G or 4G), or a proprietary point-to-point protocol. Examples include SiBEAM transceivers.

When coupled to the MDS 54, the HMD 56 may not use its dedicated power source, and thus can receive power from the MDS 54 (and vice versa). The power transceiver 64 may be configured to transfer power from the power supply 74 of the MDS 54 to the HMD 56. For example, the power transceiver 64 of the MDS 54 and the power transceiver 80 of the HMD 56 may be electrically coupled to one another via a physical connection (e.g., by electrical contacts) or a wireless connection (e.g., by power transmitter chips).

The power supply 94 can allow the HMD 56 to serve as a power source (e.g., supplemental power source) for the MDS 54. In such embodiments, the power transceiver 64 can receive power (e.g., wirelessly or via electrical contacts) from the HMD 56. Oftentimes, the HMD 56 includes the display 90, memory 88, processor 86, and a power supply 94 that is electrically coupled to the power interface 96 (e.g., a physical power port or a Qi-compliant wireless receiver). The memory 88 can store, for example, an operating system executed by the processor 86 of the HMD 56 and one or more applications that are associated with various accessories. The HMD 56 may be configured to invoke a particular application upon determining that it is docked to the MDS 54.

As noted above, various embodiments of the MDS 54 and HMD 56 can include some or all of these components, as well as other additional components not illustrated herein. For example, the MDS 54 or HMD 56 can be intended to serve as a supplemental display or camera for the other and, as such, process image data for the other device to enable offloading of processing or distributed processing.

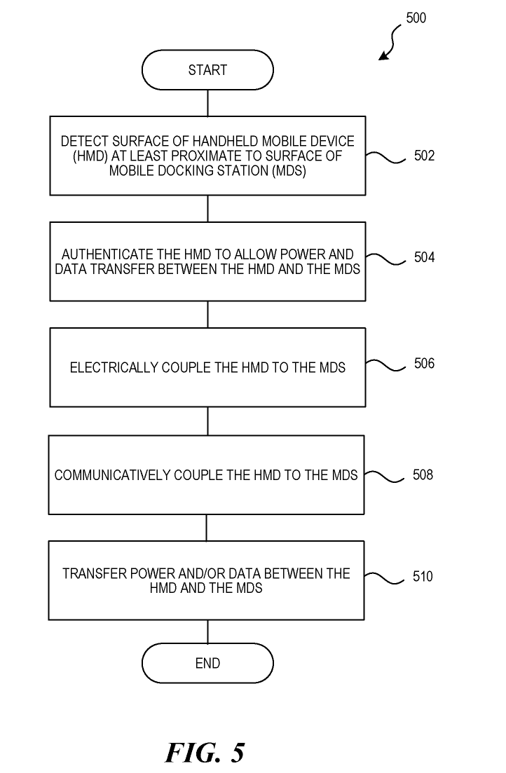

FIG. 5 is a flowchart illustrating a process 500 for electrically and communicatively coupling an HMD to an MDS according to some embodiments of the present disclosure. A user initially acquires an MDS (e.g., MDS 10, 36, 54) and an HMD (e.g., HMD 12, 40, 56) or any other suitable electronic devices. The user can then dock the HMD to the MDS. In step 502, the MDS detects a surface of the HMD that is proximate to the surface of the MDS that includes the wireless bus. For example, the MDS can detect that the HMD and the MDS are being joined magnetically or physically (e.g., via clips, connectors, or a mechanical track) to one another.

In some embodiments, the MDS can continually monitor whether an HMD has a surface proximate to a surface of the MDS having the wireless bus. For example, a processor of the MDS may be configured to detect when an HMD is placed on or near the wireless bus of the MDS. More specifically, a wireless transceiver of the MDS may be able to detect when another wireless transceiver (e.g., of the HMD) comes within a certain proximity, thereby indicating the presence of the HMD.

In step 504, the MDS can authenticate the docked HMD. For example, as the HMD is proximate to the wireless bus of the MDS, the MDS can initiate an authentication routine to enable the HMD to electrically and/or communicatively couple to the MDS. For example, the MDS can be pre-programmed by a user or a manufacturer with a passcode of a specific HMD or type of HMD. Once docked to the MDS, the HMD can transfer a passcode to the MDS. If the passcode matches the pre-programmed passcode stored in the MDS, then the HMD can be allowed to electrically and/or communicatively couple to the MDS. If the passcode does not match the pre-programmed passcode stored in the MDS, then the HMD is not enabled to transfer power or data to or from the MDS.

In step 506, once authenticated, the HMD can be electrically coupled to the MDS. In particular, the power supply of the MDS is electrically coupled to the power transceiver of the HMD. For example, a power supply of the MDS is coupled to the power transceiver that is configured to wirelessly transfer power to the power transceiver of the HMD under the control of the power circuitry of the MDS and/or HMD.

In step 508, once authenticated, the HMD can be communicatively coupled to the MDS. In particular, the communications circuitry of the MDS and/or HMD can operate to establish one or more communication links between the MDS and HMD. In particular, the MDS may also be configured to communicatively couple a wireless transceiver of the MDS to a wireless transceiver of the HMD. The wireless transceivers can permit the MDS and HMD to communicate with one another without a physical connection between the two devices. After initiating a communication link between the MDS and the HMD, the HMD can allow the MDS to utilize a new or improved functionality enabled by the HMD.

Lastly, in step 510, the MDS and HMD can freely transfer power and/or data between the two devices under the control of power circuitry and/or communications circuitry. In some embodiments, this is done automatically without requiring user input. That is, the user may be able to utilize the MDS without manually connecting/modifying physical components or installing appropriate software. For example, the MDS may automatically recognize and utilize memory provided by an external storage HMD.

Unless contrary to physical possibility, it is envisioned that the steps described above may be performed in various sequences and combinations. For instance, the MDS may not need to form both an electrical coupling and a communications coupling with the HMD. Other steps could also be included in some embodiments. For example, the HMD may automatically initiate an application associated with the MDS upon which it is docked. For example, when a camera is docked the MDS, the camera (and, more specifically, an operating system executed by the MDS) may invoke and execute a camera application and/or an image processing application.

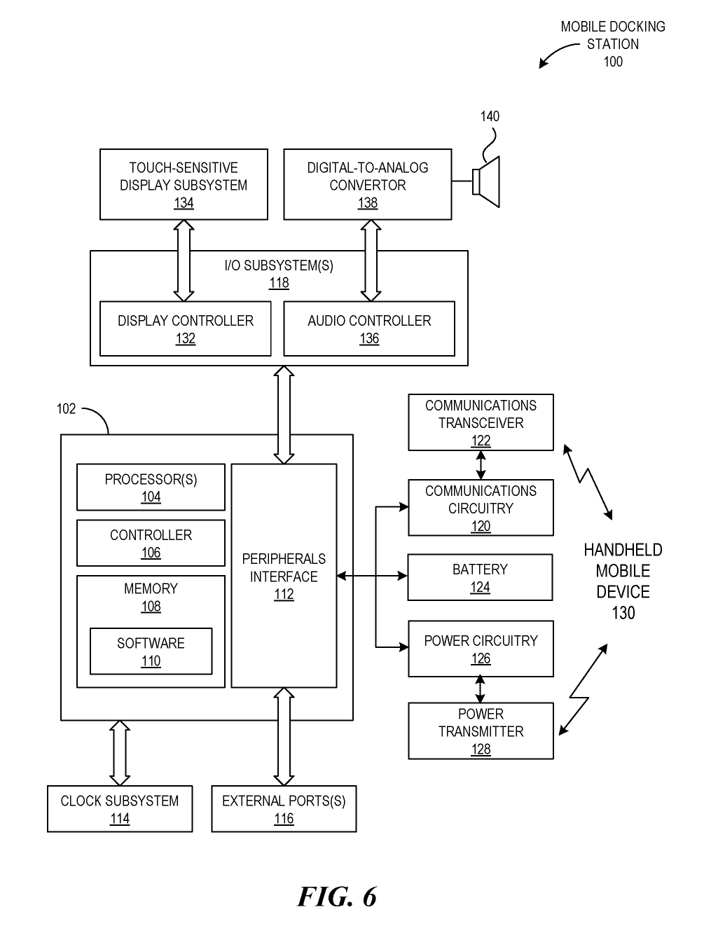

FIG. 6 is a block diagram illustrating components of an MDS in which embodiments of the present disclosure can be implemented. The MDS 100 (e.g., MDS 10, 36, 56) may include generic components and/or components specifically designed to carry out the disclosed technology. The MDS 100 may be a standalone device or part of a distributed system that spans networks, locations, machines, or combinations thereof. For example, components of the electronic device 44 may be included in or coupled to a system-on-chip, a single-board computer system, a desktop or laptop computer, a kiosk, a mainframe, a mesh of computer systems, or combinations thereof.

In some embodiments, the MDS 100 can operate as a server device or a client device in a client-server network environment, or as a peer machine in a peer-to-peer system. In some embodiments, the MDS 100 may perform one or more steps of the disclosed embodiments in real-time, near real-time, offline, by batch processing, or combinations thereof.

The MDS 100 can include a processing subsystem 102 that includes one or more processor(s) 104 (e.g., Central Processing Units (CPUs), Application Specific Integrated Circuits (ASICs), and/or Field Programmable Gate Arrays (FPGAs)), a memory controller 106, memory 108 that can store software 110, and a peripherals interface 112. The memory 108 may include volatile memory (e.g., random-access memory (RAM)) and/or non-volatile memory (e.g., read-only memory (ROM)). The memory 108 can be local, remote, or distributed. The MDS 100 can also include a clock subsystem 114 that controls a timer for use in some embodiments. The components of the MDS 100 are interconnected over a bus (not shown) operable to transfer data between hardware components.

The peripherals interface 112 is coupled to one or more external port(s) 116, which can connect to an external power source, or another electronic device. The peripherals interface 112 is also coupled to an I/O subsystem 118. Other components coupled to the peripherals interface 112 include communications circuitry 120 coupled to a communications transceiver 122, a battery 124, and power circuitry 126 coupled to a power transceiver 128. Once docked, the handheld mobile device (HMD) 130 (e.g., HMD 12, 40, 56) can transfer power and/or data with the MDS 100.

The I/O subsystem 118 may include a display controller 132 operable to control a touch-sensitive display 134 of the MDS 100. The I/O subsystem 118 also includes an audio controller 136 operable to control a digital-to-analog 138 coupled to an electroacoustic transducer such as speaker 140. The I/O subsystem 118 can include other components (not shown) to control physical buttons such as an on/off button.

The communications circuitry 120 can configure the communications transceiver 122. In some embodiments, the communications transceiver 122 can be structurally integrated with the MDS 100 (e.g., embedded in the housing or display screen) or, for example, coupled to the MDS 100 through the external port(s) 108. The communications circuitry 120 can convert electrical signals to/from electromagnetic signals that are communicated by the communications transceiver 122 the HMD 130, a network, or other devices. For example, the communications circuitry 120 can include radio frequency (RF) circuitry that processes RF signals communicated by the communications transceiver 122.

In some embodiments, the communications transceiver 122 can be programmatically controlled via the communications circuitry 120. For example, the software 110 may control or contribute to the configuration of the communications transceiver 122 via the communications circuitry 120. For example, the memory 108 may include a database used by the software 108 to configure the communications circuitry 120 or communications transceiver 122. The software 110 can be located anywhere in the MDS 100 or located remotely and communicatively coupled over a network to the MDS 100. For example, the software 110 can be in a memory to remotely configure the communications circuitry 120 and/or the communications transceiver 122.

The communications circuitry 120 can include circuitry for performing well-known functions such as an RF transceiver, one or more amplifiers, a tuner, oscillator, a digital signal processor, a CODEC chipset, a subscriber identity module (SIM card or eSIM), and so forth. The communications circuitry 120 may communicate wirelessly via the communications transceiver 122 with the HMD 130 or over a network (e.g., the Internet, an intranet and/or a wireless network, such as a cellular network, a wireless local area network (LAN) and/or a metropolitan area network (MAN)) or other devices.

The power circuitry 126 can configure the power transceiver 128. In some embodiments, the power transceiver 128 can be structurally integrated with the MDS 100 or, for example, coupled to the MDS 100 through the external port(s) 108. The power circuitry 126 can control the transfer between the MDS 100 and HMD 130. For example, the power circuitry 126 can include circuitry to process power transferred by the power transceiver 122.

In some embodiments, the power transceiver 128 can be programmatically controlled via the power circuitry 126. For example, the software 110 may control or contribute to the configuration of the power transceiver 128 via the power circuitry 126. For example, the memory 108 may include a database used by the software 108 to configure the power circuitry 126 or power transceiver 128. The software 110 can be located anywhere in the MDS 100 or located remotely and communicatively coupled over a network to the MDS 100.

The power circuitry 126 can include circuitry for performing well-known functions such as an power modulation, one or more amplifiers, a tuner, oscillator, a digital signal processor, and so forth. The power circuitry 126 may transfer power wirelessly via the power transceiver 128 with the HMD 130. For example, the power circuitry 126 can control the supply of power from the battery 124 to charge a batter of the HMD 130 via the power transceiver 128.

The software 110 can include an operating system (OS) software program, application software programs, and/or modules such as a communications module, a GPS module, and the like. For example, the GPS module can estimate the location of the MDS 100 based on the GPS signals received by a GPS receiver. The GPS module can provide this information to components of the MDS 100 for use in various applications (e.g., to provide location-based access to service providers).

A software program, when referred to as “implemented in a computer-readable storage medium,” includes computer-readable instructions stored in the memory (e.g., memory 108). A processor (e.g., processor(s) 104) is “configured to execute a software program” when at least one value associated with the software program is stored in a register that is readable by the processor. In some embodiments, routines executed to implement the disclosed embodiments may be implemented as part of OS software (e.g., Microsoft Windows® and Linux®) or a specific software application, component, program, object, module, or sequence of instructions referred to as “computer programs.”

Computer programs typically comprise one or more instructions set at various times in various memory devices of a computing device (e.g., MDS 100), which, when read and executed by at least one processor (e.g., processor(s) 104), will cause the MDS 100 to execute functions involving the disclosed embodiments. In some embodiments, a carrier containing the aforementioned computer program product is provided. The carrier is one of an electronic signal, an optical signal, a radio signal, or a non-transitory computer-readable storage medium (e.g., the memory 108).

Operation of a memory device (e.g., memory 108), such as a change in state from a binary one (1) to a binary zero (0) (or vice versa) may comprise a visually perceptible physical change or transformation. The transformation may comprise a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

The MDS 100 may include fewer components than those shown in FIG. 6, or include more components that are not shown nor further discussed herein for the sake of brevity. One having ordinary skill in the art will understand any hardware and software that is included but not shown in FIG. 6. While embodiments have been described in the context of fully functioning handheld electronic devices, those skilled in the art will appreciate that the various embodiments are capable of being distributed as a program product in a variety of forms and that the disclosure applies equally, regardless of the particular type of machine or computer-readable media used to actually effect the embodiments.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

1. A mobile docking station (MDS) comprising:
a housing;
a connectors area of a bus disposed at least partially within the housing, the connectors area enabling magnetic, electrical, and communicative coupling to a counterpart connectors area of a handheld mobile device (HMD);
a surface of the housing through which the bus that electrically and communicatively couples the MDS to the HMD;
one or more magnets of the connectors area arranged to magnetically couple the HMD to the surface of the MDS in an orientation aligned relative to the bus;
power circuitry disposed at least partially within the housing;
one or more electrical contacts of the bus disposed on the surface of the MDS and coupled to the power circuitry, the one or more electrical contacts configured to electrically couple the MDS and the HMD to enable a bi-directional transfer of power between the MDS and the HMD while one or more electrical contacts of the counterpart connectors area of the HMD physically contacts the surface of the MDS;
communications circuitry disposed at least partially within the housing; and
a wireless transceiver of the bus disposed underneath the surface of the MDS and coupled to the communications circuitry, the wireless transceiver configured to communicatively couple the MDS and the HMD for bi-directional wireless communication between the MDS and the HMD while the surface of the HMD physically contacts the surface of the MDS.

2. (canceled)

3. (canceled)

4. The MDS of claim 1, further comprising:
a battery configured to charge the HMD while electrically coupled to the MDS.

5. The MDS of claim 1, further comprising:
a battery configured for charging by the HMD while electrically coupled to the MDS.

6. The MDS of claim 1, further comprising:
a battery, wherein the MDS is configured to:
transfer power from the battery to the HMD while electrically coupled to the MDS; and
receive power from a battery of the HMD to charge the battery of the MDS while electrically coupled to the HMD.

7. The MDS of claim 1, wherein the power circuitry includes a power transceiver configured to automatically electrically couple the HMD to the MDS when the surface of the HMD contacts the surface of the MDS.

8. The MDS of claim 1, further comprising:
a recessed portion of the MDS configured to receive only a portion of the HMD, the recessed portion including the surface of the MDS.

9. The MDS of claim 1, further comprising:
a recessed portion of the MDS configured to receive the HMD, the recessed portion including the surface of the MDS.

10. The MDS of claim 1, wherein the wireless transceiver is configured to communicatively coupled the HMD and MDS by establishing at least one of a Wi-Fi, WiGig, or Bluetooth communication link.

11. The MDS of claim 1, wherein the wireless transceiver is configured to automatically communicatively couple the MDS and the HMD when the surface of the HMD contacts the surface of the MDS.

12. (canceled)

13. (canceled)

14. The MDS of claim 1, wherein the MDS is configured to authenticate the HMD in response to the surface of the HMD physically contacting the surface of the MDS such that the HMD is electrically coupled or communicatively coupled to the MDS without requiring user intervention.

15. The MDS of claim 1, further comprising:
a digital-to-analog converter configured to convert a digital audio signal received from the HMD via the communications circuitry into an analog audio signal; and
an electroacoustic transducer configured to render the analog audio signal.

16. The MDS of claim 15, further comprising:
an audio jack configured to communicate the analog audio signal to an external electroacoustic transducer coupled to the audio jack.

17. The MDS of claim 1, further comprising:
a USB port configured to communicate data received from the HMD via the communications circuitry to an external computing device coupled to the USB port.

18. The MDS of claim 14, further comprising:
media playback circuitry configured to automatically receive media data via the communications circuitry from the HMD in response to being electrically coupled to the MDS; and
a transducer configured to render the media data automatically in response to receiving the media data from the HMD.

19. A mobile docking station (MDS) comprising:
a housing;
a connectors area of a bus disposed at least partially within the housing, the connectors area enabling magnetic coupling and wireless connectivity to a handheld mobile device (HMD);
a recessed portion of the housing including a flat surface through which the bus electrically and communicatively couples the MDS to the HMD in response to a flat surface of the HMD being proximate to the flat surface of the MDS;
one or more magnets of the connectors area arranged to magnetically couple the HMD to the flat surface of the MDS in an orientation aligned relative to the bus necessary to electrically and communicatively the HMD to the MDS;
power circuitry disposed at least partially within the housing;
one or more electrical contacts of the bus disposed on the surface of the MDS and coupled to the power circuitry, the one or more electrical contacts configured to electrically couple the HMD to the MDS to enable a bi-directional transfer of power between a battery of the MDS and a battery of the HMD while a corresponding one or more electrical contacts on the surface of the HMD is proximate to the surface of the MDS; communications circuitry disposed at least partially within the housing; and
a wireless transceiver of the bus disposed underneath the surface of the MDS and coupled to the communications circuitry, the wireless transceiver configured to communicatively couple the MDS to the HMD for bi-directional wireless communication between the MDS and HMD while the surface of the HMD is proximate to the surface of the MDS.

20. A mobile docking station (MDS) comprising:
a connectors area of a bus including:
one or more magnets arranged to magnetically couple a handheld mobile device (HMD) to a surface of the MDS in an orientation aligned relative to the bus;
one or more electrical contacts coupled to power circuitry that electrically couples the MDS to the HMD to transfer power between the MDS and the HMD while the surface of the MDS is magnetically coupled to a surface of the HMD; and
a wireless transceiver coupled to communications circuitry that communicatively couples the MDS to the HMD to wirelessly communicate data between the MDS and HMD while the surface of the MDS is magnetically coupled to the surface of the HMD;
wherein the MDS is configured to automatically authenticate, electrically couple, and communicatively couple the HMD to the MDS in response to the surface of the HMD physically contacting the surface of the MDS such that the MDS automatically renders media being processed on the HMD.
